(19) United States
(12) Patent Application Publication
(10) Pub. No.: US 2020/0036803 A1
(43) Pub. Date: Jan. 30, 2020

(54) Social Metrics Connection Representor, System, and Method

(71) Applicant: Star2Star Communications, LLC, Sarasota, FL (US)

(72) Inventor: Sergey Galchenko, Aurora, OH (US)

(21) Appl. No.: 16/043,664

(22) Filed: Jul. 24, 2018

(51) Int. Cl. H04L 29/08; H04L 29/06; H04L 12/18

(52) U.S. Cl. CPC H04L 67/22; H04L 12/1831; H04L 65/4053

(57) ABSTRACT

The present invention is directed towards a communication connection representor comprising a network monitor for interpreting a communication session notification initiated within a network, the communication session comprising an Internet protocol (IP) address of an initiating device, routing information, and a session type. The representor also comprises an activity detail collector for collecting and storing activity detail in a database, the activity detail comprising at least the IP address of the initiating device, an IP address of the destination device, the session type, a session duration, and a time stamp. The representor further comprises an evaluator for assessing the collected activity detail, using a set of weighted values. The representor further comprises a constructor for aggregating the assessed activity detail into a representation comprising a connection graph. The representor further comprises a controller capable of receiving the communication session notification and transmitting the connection graph to a display device.

### FIELD OF THE INVENTION

The present inventive devices, systems, and methods generally relate to electronic communication systems, particularly electronic communication systems for assessing collected communication data, aggregating such assessed communication data, and representing the aggregated communication data in a constructed, novel format.

### BACKGROUND OF THE INVENTION

Business intelligence is a concept that typically involves the delivery and integration of relevant and useful business-related information for an organization. Many business entities use business intelligence to identify and/or monitor business trends in order to adapt quickly to the changing environments within their respective industries. Generally, business intelligence comprises the strategies for and the data analysis of business information, often times providing historical and predictive views of business operations (i.e., the realization of value derived from assets owned by the entity). Common functions of business intelligence technologies include reporting, analytics, data mining, benchmarking, predictive analytics, and prescriptive analytics. Business intelligence technologies can handle large amounts of structured and sometimes unstructured data to help identify, develop, and otherwise create new business opportunities. Identifying new opportunities and implementing an effective strategy based on insights can provide businesses with a competitive market advantage and long-term stability.

Existing business intelligence systems do not generally take into account the connections and metrics associated with these connections internally within an entity or a grouping of entities when identifying, developing, and otherwise creating new business opportunities based on the collected stream of business data. Generally speaking, entities are interested in how consumers and businesses are buying products and services and using this information to develop products that match the current consumption trends. One factor that is often overlooked as part of the analytics collection is how individuals within a business entity use the entity's own products and services, communicate these products and services to one another within the entity, and how the products and services are communicated externally to consumers and businesses in the marketplace.

As such, a reliable device, system, and method are needed to organize and visualize these internal communications and their associated metrics into a representation in such a way as to provide insights which are a value-add to an effective strategy to develop and market products and services, to the competitive advantage and long-term stability of a business entity.

### SUMMARY OF THE INVENTION

It is, therefore, an object of the present invention to provide a communication connection representor, a system incorporating the communication connection representor, and a method for use of such device and system, respectively.

The present invention may optionally operate within a number of communications and/or network environments, for example, but in no way limited to, the public Internet, a private Internet or Intranet, a network on one side of a third-party provided network address translation implementation, a data transport network or a series of networks, a communications network or series of networks, a non-optimized communications network or series of networks, an optimized communications network or series of networks, and the like.

In one exemplary embodiment, a communication connection representor is provided. This connection representor, in an exemplary aspect, can function to construct a representation of a communication flow within an entity, for example, an entity which is oftentimes a business entity, such as, for example, a corporation, a company, or the like, one location of an entity, a series of connected locations of a single entity, a series or grouping of connected entities, and the like. The inventive communication connection representor device can comprise a network monitor, an activity detail collector, an evaluator, a constructor, and a controller.

In one exemplary aspect of the present device, the network monitor can interpret a network notification that a communication session has been initiated within a network associated with the entity. The communication session can comprise any one, all, or any combination of the following: an Internet protocol (IP) address of a device initiating the communication session (otherwise described as an “initiating device”), routing information to route the communication session through the network to another device or group of devices (otherwise described as a “destination device”), and an at least one session type.

In another aspect of the present device, the activity detail collector can collect and store an at least one activity detail associated with the communication session in a database. As used through this specification and the claims, the activity detail can comprise any one, all, or any combination of the following: an IP address of an initiating device, an IP address of a destination device, an at least one session type, a session duration, and a time stamp.

In yet another aspect of the present device, the evaluator can assess a collected at least one activity detail. The evaluator can optionally use a set of weighted values to assess this collected at least one activity detail. In these exemplary embodiments, the set of weighted values can be stored at the evaluator.

In yet still another aspect of the present device, the constructor can aggregate an assessed at least one activity detail into a representation, such as, in one example, a connection graph.

In a further aspect of the present device, the controller can receive a notification of the communication session initiated within the network and transmit the connection graph via a network to a display device.

The following are either or both additional and exemplary aspects of the present exemplary embodiment, one or more of which can be combined with the basic inventive device embodied above:
the set of weighted values can be set by an entity network administrator based on an entity profile;
the set of weighted values can comprise weights for at least one connection type, at least one strength of a connection, at least one secondary connection, and a predetermined organization chart for the entity;
the set of weighted values is dynamic based on a network criteria;
wherein the set of weighted values is static;
the network monitor observes a limited network for interpreting a communication session notification, wherein the limited network can further comprise a network accessible only by an entity;
the network monitor observes all available networks for interpreting a communication session notification, wherein the all available networks can comprise a plurality of networks accessible by an entity and at least one external party;
the at least one activity detail can further comprise a frequency of at least one term used within a communication session;
the at least one activity detail can further comprise a record of at least one document exchanged; and
the at least one activity detail can further comprise a purpose of a communication session.

In another exemplary embodiment, a system is provided for constructing and displaying a communication flow within an entity. The system can comprise an entity network, an at least one first asset operably connected to the entity network, an at least one second asset operably connected to the entity network, a display device operably connected to the entity network, and at least one communication connection representor for constructing a communication flow between the at least one first asset and the at least one second asset. The at least one communication connection representor as described herein can have the same, substantially the same, and/or similar functionality to the communication connector representor described above.

In another exemplary embodiment, methods for optimally operating the communication connection representor and the system are provided. Such exemplary methods combine the basic inventive concept(s) as embodied in the above exemplary communication connection representor and exemplary system, as stated above.

These and other exemplary aspects of the present basic inventive concept are described below. Those skilled in the art will recognize still other aspects of the present invention upon reading the included detailed description.

### DETAILED DESCRIPTION OF THE DRAWINGS

The present invention is illustrated by way of example, and not limitation, in the figures depicted in the following drawings.

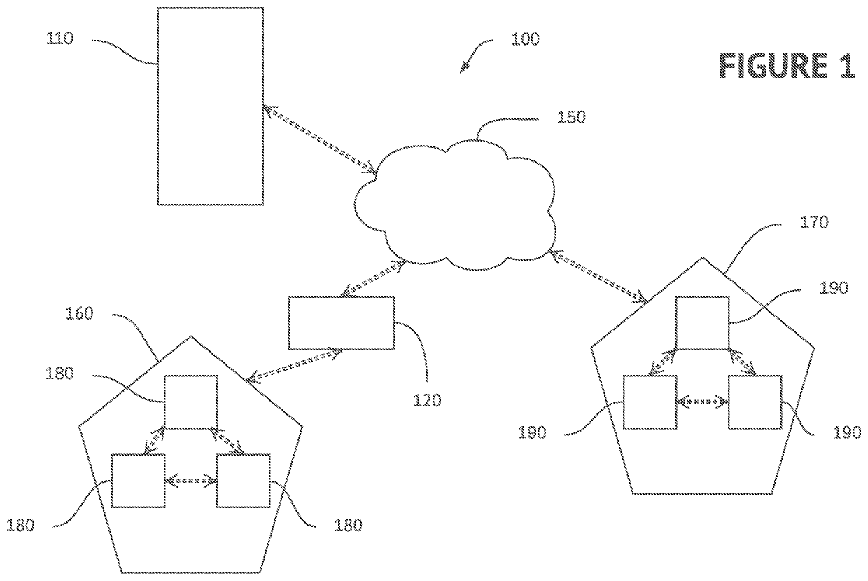

FIG. 1 illustrates a representative communications system environment within which the present invention may operate.

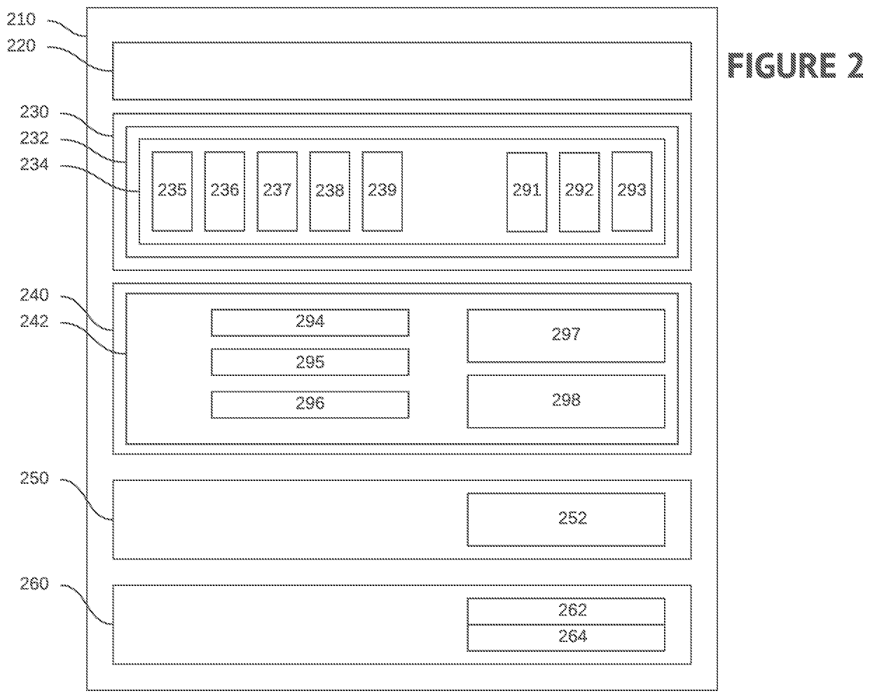

FIG. 2 illustrates an exemplary embodiment of the present invention, an exemplary communication connection representor.

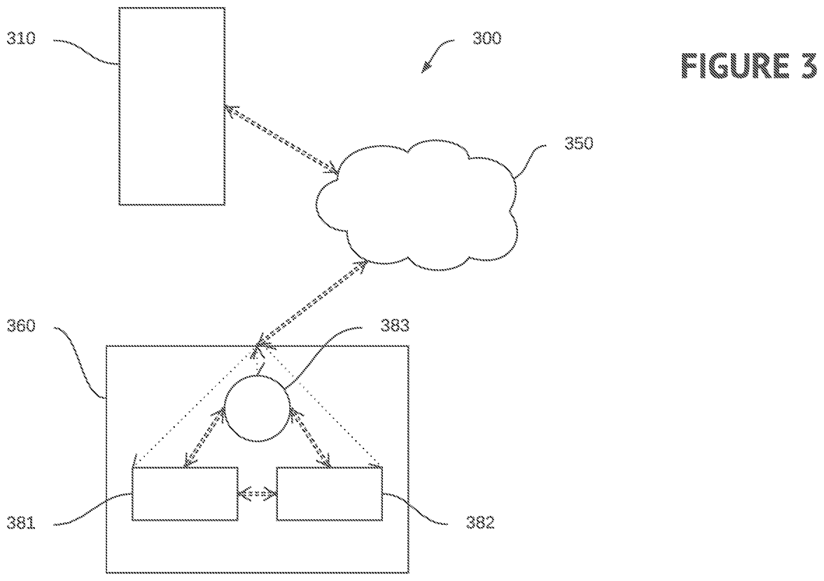

FIG. 3 illustrates one exemplary embodiment of the present invention, a system, which may comprise at least one element or aspect of the representative communications system environment illustrated in FIG. 1, in which a communication connection representor may operate.

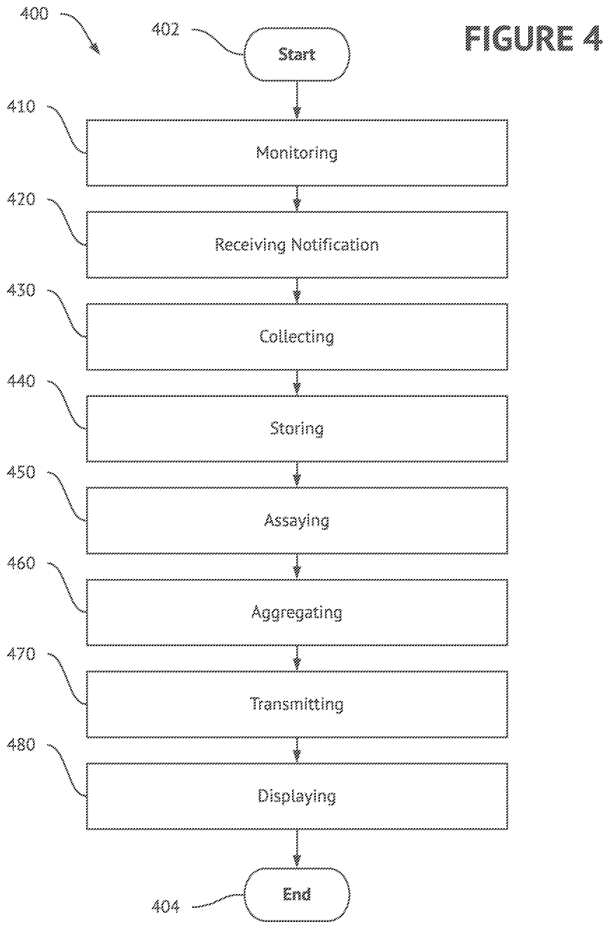

FIG. 4 illustrates one exemplary aspect of the present invention, an exemplary method for the operation of at least one embodiment of a communication connection representor.

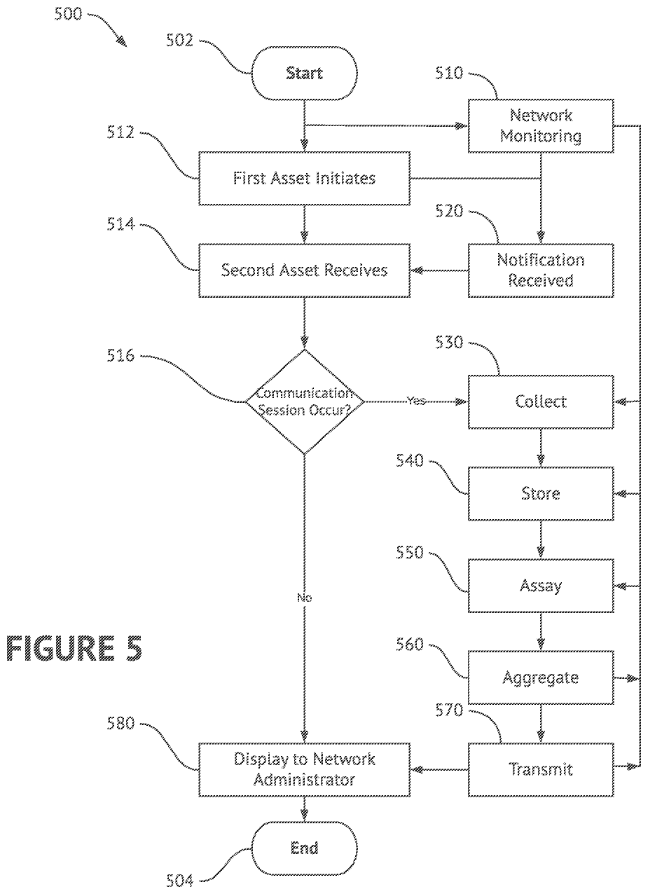

FIG. 5 illustrates one exemplary aspect of the present invention, an exemplary method for use of at least one embodiment of the system as illustrated in FIG. 3.

### DETAILED DESCRIPTION OF THE INVENTION

The present invention will now be described more fully herein with reference to the accompanying drawings, which form a part of, and which show, by way of illustration, specific exemplary embodiments through which the invention may be practiced. This invention may, however, be embodied in many different forms and should not be construed as limited to the exemplary embodiments set forth below. Rather, these exemplary embodiments are provided so that this disclosure will be thorough and complete, and will fully convey the scope of the invention to those skilled in the art. Among other things, the present invention may be embodied as devices, systems, and methods. Accordingly, various exemplary embodiments may take the form of entirely hardware embodiments, entirely software embodiments, and embodiments combining software and hardware aspects. The following detailed description, is, therefore, not to be taken in a limiting sense.

Throughout this specification and claims, the following terms take the meanings explicitly associated herein, unless the context clearly dictates otherwise. The phrases “in one embodiment” and “this exemplary embodiment” do not necessarily refer to the same embodiment, though they may. Furthermore, the phrases “in another embodiment,” “additional embodiments,” and “further embodiments” do not necessarily refer each or collectively to a different embodiment, although they may. As described below, various embodiments of the invention may be readily combined, without departing from the scope or spirit of the invention.

In addition, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes one of the exemplary embodiments of the present invention, in order to provide a basic understanding of some aspects of the invention. This brief description is not intended as an extensive overview, nor is not intended to identify key or critical elements, to delineate, or otherwise, narrow the scope. Its purpose is simply to present concepts in a simplified form as a prelude to a more detailed description which is presented later. The present invention, generally, is directed towards devices, systems, and methods for capturing the communication detail, also known throughout this specification as “social metrics” between individuals, for example, within an entity or between entities. The social metrics can be assessed, analyzed, and aggregated in such a way that trends and a representation of the communication flow can be determined on a variety of levels, such as, for example, within a department or practice group, at a location level, at an entire entity level, and the like. Information and perspective obtained from this assessed, analyzed, and aggregated communication data may, by way of example and no way in limitation, allow an entity to determine process inefficiencies within a department, visualize how and where communications fall apart with end-user customers, spur an entity to create new, streamlined systems and processes or integrate various enterprise computing systems within the entity, and the like.

Below, exemplary embodiments will be provided in conjunction with the attached drawings. The written description will begin with reference to FIG. 1 and will include a high-level, generalized description of a “communication system” in which the present invention can be practiced. FIGS. 2 through 5 thereafter will discuss various aspects and embodiments of the present invention, in more detail.

FIG. 1 illustrates an embodiment of a communication system 100, which is an exemplary environment in which the present inventive concept and its individual elements can be practiced, constructed and operated, in whole, in part, and in any order or combination. Communication system 100 includes a communication server 110, at least one communication node 120, and at least one exemplary network 150. Communication system 100, generally, involves the connection of the various elements and components described herein for the transmission of communication sessions via electronic transfer of data over one or more third-party networks (i.e., network 150), which generally includes transfer through a series of communication nodes (not shown). A communication session generally comprises data packets (either or both signaling and data packets) passed using a communication protocol and generally relating to one or more of the following non-exhaustive application types: audio only, audio and video, audio and data, or any combination of audio, video, and data over a digital medium. One knowledgeable in the art should understand that the phrase “communication session” is generally synonymous with the term “connection.” As such, it should be realized that one exemplary embodiment of communication system 100, can include, but is not limited to, an Internet protocol (IP)-based communication system that provides one or more users with an end-to-end, fully managed and monitored system for transporting audio, video, and data traffic over third party networks.

As illustrated, communication system 100 comprises a plurality of components in addition to communication server 110, communication node 120, and network 150, for example, entity facilities 160,170 which house one or more communication asset 180,190 (each individually an asset 180,1900 or collectively assets 180,190) for providing communication sessions (i.e., both incoming and outgoing), associated with assets 180,190. Within this exemplary embodiment, communication sessions may be between the illustrated assets 180, between assets 180 and one or more assets 190, as well as between assets 180,190 and other assets not shown. It should be understood that a communication session between assets 180,190, and assets not shown can be, for example, in a two-party manner, or can involve other assets (also not shown) in a multi-party manner, such as, in a multi-asset (i.e., multi-user) communication session.

In FIG. 1, two exemplary entity facilities 160,170 are shown. But it will be understood that this is for illustrative purposes only. According to aspects of this written disclosure and the claims, assets are not necessarily tied to facilities, no relation necessarily exists between various facilities (not shown), and facilities 160,170 can be located in different geographical locations. Communication sessions involving assets 180,190 located in such facilities 160,170, respectively, occur via one or more networks (for example, network 150) and are typically associated with one or more of the following, by way of example and not limitation, a web-deployed service an associated architecture, a cellular data network, a cloud-based system, secure data networks, and gateways/firewalls that provide information security, and the like. Moreover, as will be understood and appreciated, various networking components such as routers, switches, hubs, and the like, are generally also involved in transmitting communication sessions, but not illustrated for simplicity purposes.

Assets 180,190 generally are defined as electrical or electronic equipment that can be connected to an IT infrastructure and that can enable electronic communications (e.g., communication sessions). For example, and in no way in limitation, assets 180,190 may comprise any singular or combination of a VoIP phone, a mobile phone, a fax machine, a conventional Plain Old Telephony System (POTS) phone, a smartphone, a cordless phone, a conference room speakerphone, a computer, a Bluetooth-enabled phone, a laptop, audio/video conferencing equipment, electronic gaming equipment, a printer, or more generally, any kind of computing device which can connect to a network and to or from which a user can operatively practice a data transmission or communication function. As will be understood and appreciated, there is no limitation imposed on the number of assets, asset types, brands, vendors, and manufacturers, etc. that may be used in connection with embodiments of the present disclosure.

In a traditional communications network, such as this exemplary embodiment illustrated in FIG. 1, an outgoing (which can also be known as “initiated,” “placed,” “sent,” and in purely voice sessions, “terminating”) communication session will travel from asset 180 via network 150, and in one example, it may become IP traffic that needs to be converted into telephony traffic (via, in illustrative option, an IP/PSTN gateway, not shown) and can be delivered to one or more of assets 180,190 or another asset or assets (not shown). The reverse happens for an incoming communication session (which can also be known as “received,” “delivered,” and in purely voice sessions “originating”). As will be discussed in reference to this FIG. 1, additional configurations of communication traffic will be contemplated, for example, generated via assets (not shown), and passed from communication nodes 120 to network 150 and thereafter routed through communication server 110. Additional embodiments contemplate communication traffic generated via assets 180 and passed from communication node 120 to network 150. In one example, incoming traffic to facility 160 may be directed to communication server 110 and thereafter communication node 120 for eventual delivery to specific assets 190, via, for example, another communication node (not shown), and the like. In an alternative example, incoming traffic may be redirected to an automated attendant, call queues, voicemail, or an off-premises device (e.g., a user's mobile phone or home phone).

Though various communication traffic models are contemplated herein and are functionally operable via the various novel elements of the present inventive concepts and their applicable device elements and system components, as will be discussed in more detail below, FIGS. 2 through 5 will discuss almost exclusively (but in no way is limitation herein intended) communication sessions travelling between concurrent assets, for example between assets 180 housed within entity facility 160, only.

According to one embodiment, and as shown in FIG. 1, communication server 110 may be connected to one or more of communication nodes 120 and networks 150. Through these connections, as shown, communication server 110 can be operatively connected to one or more of the entity facilities 160,170, and in additional exemplary embodiments, one or more remotely-located communication server modules (not shown). Thus, assets 180 can be managed and controlled by communication server 110 or remotely via communication server modules, which in this exemplary embodiment, can be communication node 120, via network 150. In contrast and for purposes of illustration only, assets 190 are intended to represent assets that are not managed and controlled by communication server 110. In one embodiment, communication server 110 monitors and collects real-time and historical network characteristics, applies organization level methodologies for specific business requirements, embodied as executable instructions stored in a form of computer-readable media related to network 150 characteristics, evaluates various communication session routes/paths, and if necessary modifies communication routes to account for the application of entity-specific requirements and real-time characteristics of network 150.

Communication server 110, as shown in FIG. 1, is intended to be any singular or collection of computer servers or communication nodes that provide a suite of hosted services to create a complete, feature-rich communication system (i.e., a variety of features and functions which may be monitored and categorized by the inventive representor). As such, communication server 110 may comprise any combination of computing components, by way of example, but in no way required or limited to, processing units (CPUs), mass memory, buses, RAM, ROM, and other storage means (all of which are not shown for simplicity purposes). In this exemplary embodiment, mass memory may include an example of computer-readable storage media for storing information such as computer-readable instructions, data structures, program modules or other data, basic input/output system (“BIOS”) for controlling low-level operations of communication server 110, as well as an operating system for controlling the operation of communication server 110. It should be appreciated that these components may include a general-purpose operating system such as a version of UNIX® or Linux™. The operating system may include, or interface with, Java virtual machine modules that enable control of either or both hardware components and operating systems operations, via Java application programs.

Additional exemplary embodiments of communication server 110 can optionally include any singular or collection of computer servers or communication nodes for storing data associated with providing communication sessions, i.e., databases further comprising directories of information identifying characteristics relating to various communication nodes, also including but not limited to, communication session activity detail, a catalog of supported or available codecs, and the like. Non-limiting examples of such directory information can include, for example, IP addresses of the respective communication nodes, a network type (i.e., which of a variety of available networks a communication is in or associated with), a communication session type or communication session types compatible with a communication node, or network, and a type of application data (i.e., audio, video, data, or any combination thereof) the respective communication node processes. Databases, in these exemplary embodiments may, in one example, be relational, which can be defined as tabular databases with data defined so that it may be reorganized and accessed in a number of ways, and in another example distributed, which can be defined as dispersed or replicated databases located among different points in the networks. These examples, however, are exemplary only and communication server 110 can have any other configuration which is operably functional for communication system environment too.

In one exemplary embodiment of the communication system 100, any one, all, or any combination of the component elements of the “communication connection representor” discussed in more detail with reference to FIG. 2 may optionally be embodied within, in connection with, or wholly as communication server 110. Additional embodiments are contemplated where embodiments of communication server 110 may be in direct connection with certain entity-level assets, for example, any one or a combination of assets 180, 190, specifically for the purpose of providing the functionality of certain of the communication connection representor elements, while additional elements of the inventive representor device are embodied as, within, in connection with, or wholly as the inventive representor device.

In FIG. 1, as shown, communication node 120 is operatively connected to the communication server 110, via one or more networks, such as, for example, network 150, including but not limited to the Internet, another public network, or a private network. In general, communication node 120 can be any type of IP-enabled device that connects to a network (such as network 150) and enables communication sessions. As referred to throughout this specification, communication node 120 can be, but is not limited to, a class of nodes that are “compliant” with communication server 110, which is a communication node either or both operated and managed, or capable of being controlled, managed, or manipulated by an embodiment of communication server 110, or a class of nodes that are not compliant with communication server 110, which can be nodes which cannot be either or both operated and managed, or capable of being controlled, managed, or manipulated by an embodiment of communication server 110. Non-limiting examples of communication node 120 include network edge devices, provisioning servers, route servers, media proxy servers, statistics servers, general purpose computers, dedicated PBX servers, network-attached component devices, proxies, gateways, border controllers, or other specific computing devices or servers that can operate “communication server-compliant” or “non-communication server-compliant” software.

In additional embodiments, communication node 120 can be self-contained, compact, communication nodes running proprietary software from flash memory or a Solid State Drive (SSD) that provide service level guarantees to communication sessions associated with assets 180, to increase the robustness of the tracked communications sessions. In such embodiments, communication node 120 is generally responsible for collecting network 150 characteristics, including but not limited to, packet loss, round-trip times, transfer speed, jitter, and the like, and interact with applications running on assets 180 and associated network infrastructure. Generally, communication node 120 is operatively connected to communication server 110 via network 150 to exchange optimal routing information on a periodic or continual basis.

According to one aspect, communication node 120 is generally used to gather information about the assets 180 and conditions of network 150 in a periodic manner to assess characteristics of potential communication paths and other network conditions. It will be appreciated by one skilled in the art that because of the complex interconnections of a large number of networks with varying network characteristics and the way information is routed through network elements, as is illustrated in one example according to a “guarantee-less paradigm” of IP generally, the quality of communication sessions occurring via network 150 is generally unpredictable and unreliable. For example, some nodes, one exemplary representation being communication node 120, may be down or damaged, some nodes may have faster computational capabilities over other nodes, some nodes encounter more network congestion than other nodes, some communication nodes may only accept or allow the transfer of communication sessions having a specific session type, others may only be operatively functional within a public or private network, and the like. In addition to communication server 110, as presently disclosed, communication server 110 may, among other things, be used to monitor the quality of network 150, communication node 120 may also monitor the quality of network 150 to provide reliable and optimized communication sessions between assets, for example, assets 180,190.

In one exemplary embodiment of the communication system 100, any one, all, or any combination of the component elements of the communication connection representor discussed in more detail with reference to FIG. 2 may optionally be embodied within, in connection with, or wholly as a communication node, such as, for example, communication node 120. Additional embodiments are contemplated where embodiments of communication node 120 may be in direct connection with certain entity-level assets, for example, any one or a combination of assets 180,190, specifically for the purpose of providing the functionality of certain of the communication connection representor elements, while additional elements of the inventive representor device are embodied as, within, in connection with, or wholly as the inventive representor device.

It will be further understood that the terms “network,” “networks.” “first network,” “second network,” “at least one network,” or “networks 150” or each individually referenced as a network (i.e., network 150) as used herein generally include any kind of computer-enabled, IP-enabled, or other digital network for transporting data or traffic associated with communication sessions, and generally include a network in a system of interconnected computing devices, nodes, or assets. As illustrated, network 150 represents a connected yet different network in a series. In one example, a network includes the Internet that is a global system of interconnected computers that use the standard IP suite to serve users worldwide with an extensive range of information resources and services. It should also be understood that the term “Internet” as used herein and generally, in reality, is a network of networks consisting of millions of private, public, academic, business, and government networks, of local to global scope, that is linked by a broad array of electronic, wireless and optical technologies. As described in reference to this specification and the claims, communication server 110, communication node 120, and assets 180,190 generally connect to at least one network, and the at least one network may comprise one or more communication nodes and network edge devices (not illustrated) which will optimally include communication node 120 and network 150.

Customarily, such networks are offered as commoditized services by third-party Internet service providers (ISPs) and include a plurality of one or more third-party sub-networks that are usually owned by third-party network providers or third-party carriers. Such sub-networks can be hard-wired or wireless, including but not limited to, cellular, optical fiber, Wi-Fi, WiMax®, SD-WAN, proprietary networks, and the like, as should occur to one skilled in the art. It should also be understood by one skilled in the art that network 150 can further include PSTN nodes and IP-PSTN gateways at the boundary of IP networks (not shown), for conversions between PSTN traffic and IP traffic.

As will be described in greater detail herein, it will be understood that further embodiments provide the functionality of collecting, assessing, aggregating, and constructing into a representative model the social metrics of a communication session and communication session routes with either or both incoming and outgoing communication sessions associated with the various application or session types (e.g., voice-based applications, video-based applications, multimedia-based applications, file download applications, email applications, etc.) and within an entity, entity locations, between entities and the like, across one or more, but at least one network, such as network 150. Particular communication session routes and paths may comprise a plurality of either or both intermediary and forwarder nodes optimally configured for a one or more certain communication session types (not shown). For purposes of this specification and as used throughout this specification and the claims, it should be noted that communication node 120 may optionally be one of an originating node, one from which a communication session is initiated or terminated, an intermediary node, one which is along the path (i.e., route) through which the communication session is routed (e.g., neither an originating or destination node), or a destination node, one at which a communication session ends or originates.

FIG. 2 illustrates one exemplary embodiment of a communication connection representor 210. As discussed with reference to this and the remaining figures, communication connection representor 210 is an operably functional device for determining and displaying communication flow within an entity. Generally speaking, communication connection representor 210 can comprise any one or a series of connected IP-enabled device or devices that can connect to a network and can monitor communication sessions, by way of example and no way in limitation, a desktop computers, laptops, handheld computers or tablet devices, smartphones, and in additional embodiments, communications and network devices such as communication nodes, network edge devices, provisioning servers, route servers, media proxy servers, statistics servers, or the like. Additional embodiments contemplate where communication connection representor 210 may also be devices such as communication nodes like PSTN nodes (i.e., nodes that are maintained by third-party communication providers), PBX nodes (i.e., nodes that are connected to a PBX), and the like.

It is further contemplated that communication connection representor 210 includes computing elements (not shown) which operate as a central processing unit (CPU), which can generally be defined as the electronic circuitry within a computing device that carries out the method steps or instructions of a native or stored computer program by performing the basic arithmetic, logical, control and input/output (I/O) operations specified by the instructions. These instructions to be executed are generally kept in some kind of memory. These processing and operational functions will be discussed in more detail below with reference to controller 260.

Communication connection representor 210, as illustrated in FIG. 2, further comprises a number of component elements, however, additional embodiments are contemplated where fewer or additional computing elements are also present as part of communication connection representor 210, and FIG. 2 shall not be construed in any way to limit the inventive concept to only those elements as illustrated. As shown, communication connection representor 210 further comprises a network monitor 220, an activity detail collector 2300, an evaluator 240, a constructor 250, and a controller 260. Each will be discussed in turn, in more detail, below.

Network monitor 220, as illustrated in FIG. 2, can interpret a network notification that a communication session has been initiated within a network associated with an entity. For purposes of this specification and claims, a network notification can be defined as an act or instance of making known, via any combination of software and hardware technologies, a message to a recipient (i.e., network monitor 220) via a network connection or route. In one example, a network notification can be an email, a digital flag or message, a signal, and the like. Also, a communication session may be defined as the electronic transfer of data via one or more networks. Generally, communication sessions are transferred from an initiating point (an endpoint, asset, such as, for example, assets 180,190 illustrated in FIG. 1, or the like) through a series of communication nodes to reach a destination point.

A communication session generally comprises data packets (i.e., signaling packets, data packets, or a combination of signaling and data packets) passed through a communication protocol and generally relating to one or more of the following application or session types: audio only, data only; video only; audio and video, audio and data; data and video; or audio, video, and data over a digital medium. For purposes of this specification and the claims, a communication session contemplated as part of the inventive concept comprises a combination of signaling and data packets which comprise at least an Internet protocol (IP) address of an initiating device from which the communication session has been initiated, routing information to route the communication session through a network to a destination device, and at least one session type.

An Internet Protocol address (IP address) can be a numerical label assigned to each device connected to a network that uses the Internet Protocol for communication. An IP address generally serves at least two principal functions: host or network interface identification and location addressing. Assignments of IP addresses to a device may be static (fixed or permanent) or on a dynamic (ever-changing) basis, depending on the needs of an entity or its Internet provider. Generally, the header of each IP packet of a communication session contains the IP address of the sending host (i.e., the initiating device). The initiating device may optionally use, for example, geolocation software to deduce an IP location of a communicating peer, or the destination device may generally be known (in one example, because the devices are connected within an Intranet not connected to the public Internet).

Routing information to route a communication session through a network to destination device can be defined, in one exemplary embodiment, as a routing information protocol (RIP), otherwise known as a dynamic protocol used to find the best route or path from end-to-end (source to destination) over a network by using any one or a combination of a proprietary or generally industry standard routing metric, hop-count algorithm, and the like, depending on the needs of the entity from which the communication session has been initiated and its Internet provider requirements and offerings.

As discussed above, a session type can generally be defined as a predetermined class or categorization of communication sessions, including but not limited to, voice-based sessions, video-based sessions, data sessions such as multimedia-based sessions, file download sessions, email sessions, and the like.

Network monitor 220 operates within a communication connection representor 210 to monitor a network and be available to receive notification of the initiation of a communication session (generally known as “network monitoring”). Network monitoring, as contemplated herein, can comprise any combination of computing devices or elements that review a network for slow or failing components, commonly a part of what is known in the art as “network management.” Network monitoring elements commonly examine a network for problems caused by overloaded or crashed servers, the efficacy of network connections, and information relating to other devices connected to the network, however, additional monitoring functions can be programmed based on the needs of a network administrator, as necessary. Common measurements taken by network monitoring elements include response time, availability and uptime, consistency of connections, and reliability measurements.

Network topography and route analytics are also important areas of network management, with network topography relating to monitoring the health of various links in a network using end-to-end messaging protocols transmitted throughout a network. Route analytics, on the other hand, can include methods, systems, algorithms, and tools to monitor the routing posture of connected networks. In exemplary embodiments of the inventive concept, network monitor 220 can optionally be any combination of computing hardware or software that is functionally operable to keep track of system resources, networking information, and the like, additionally may include application performance management methods, systems, and algorithms, for example, to monitor and manage the performance and availability of various application elements within communication connection representor 210, in one example, or any other computing element or peripheral coupled to or connected to network monitor 220 and communication connection representor 210.

One factor for which network monitor, in additional exemplary embodiments, measures for can be “asymptotic throughput.” also known as “asymptotic bandwidth,” especially for a packet-mode communication network (such as, for example, the exemplary communication system 100 illustrated in FIG. 1). Asymptotic throughput can be defined as the value of the maximum throughput function, when the incoming network load approaches infinity, either due to a message size as it approaches infinity or the number of data sources is very large. Asymptotic throughput is usually estimated by sending or simulating a very large message (sequence of data packets) through the network and measuring the network path throughput in the destination node or destination device. Traffic load from other sources may reduce this maximum network path throughput. Alternatively, a large number of sources and sinks may be modeled, with or without flow control, and the aggregate maximum network throughput measured (the sum of traffic reaching its destinations). Asymptotic throughput algorithms may also be used in modeling performance on massively parallel computer systems, where system operation is highly dependent on communication overhead, as well as processor performance (in systems such as the exemplary communication system 100, illustrated in FIG. 1). In these applications, asymptotic throughput algorithms and calculations generally include the number of processors, so that both the latency and the asymptotic throughput are functions of the number of processors. Such asymptotic throughput, though generally considered a “system” or general “network” issue, may be determined to be an important activity detail of an entity's communication system, which any statistics collected as contemplated in reference to activity detail collector 230, discussed below, may contribute to downtime or slow connections for communication sessions, or otherwise contribute to a inefficiency trend for a particular module of an entity.

Channel efficiency, also known as bandwidth utilization efficiency, is the percentage of the net bitrate (in bit/s) of a digital communication channel that goes to the actually achieved throughput. For example, if the throughput is 70 Mbit/s in a too Mbit/s Ethernet connection, the channel efficiency is 70%. In this example, effective 70 Mbit of data are transmitted every second. Channel utilization can be a term related to the use of the channel disregarding the throughput. These types of algorithms may count not only the data bits but also the overhead that makes use of the channel. The transmission overhead can generally be defined as preamble sequences, frame headers and acknowledge packets. These definitions assume a noiseless channel. Otherwise, the throughput would not be only associated with the nature (efficiency) of the protocol but also to retransmissions resultant from the quality of the channel. In a simplistic approach, channel efficiency can be equal to channel utilization assuming that acknowledge packets are zero-length and that the communications provider will not distinguish any bandwidth relative to retransmissions or headers. Therefore, certain texts cause a difference between channel utilization and protocol efficiency. These factors may also contribute to downtime or slow connections for communication sessions, or otherwise contribute to an inefficiency trend for a particular module of an entity.

In a point-to-point or point-to-multipoint communication link, such as, for example, a communication system as illustrated in FIG. 3, and, for purposes of the illustrated communication connection representor 210 presented here as part of FIG. 2 which may be operably functional in such system, when only one terminal is transmitting, the maximum throughput is often equivalent to or very near the physical data rate (the channel capacity), since the channel utilization can be almost 100% in such a network, except for a small inter-frame gap. Ensuring that multiple users can harmoniously share a single communications link requires some kind of equitable sharing of the link, which can be an important function and purpose of any network monitor, specifically for purposes of this FIG. 2, communication connection representor 210. If a bottleneck communication link offering data rate “R” is shared by “N” active users (with at least one data packet in the queue), every user typically achieves a throughput of approximately R/N, if fair queuing best-effort communication is assumed.

Additional embodiments of network monitor 220 are contemplated, where, in one example, network monitor 220 observes a limited network when interpreting a communication session notification. In these exemplary embodiments, a limited network can be defined as a network accessible only by the entity, i.e., a private network or Intranet. Additional embodiments are also contemplated where, in another example, network monitor 220 observes all available networks for interpreting a communication session notification. In these exemplary embodiments, all available networks may generally be defined as one or more, a series of, or a plurality of networks accessible by the entity and at least one external party (i.e., a party who is not the entity).

FIG. 2 further illustrates an activity detail collector 230, further comprising database 232 and activity detail 234. In one exemplary embodiment, as illustrated here as part of FIG. 2, activity detail collector 230 is functional to collect and store (for example, within database 232) one or more, but in no event less than at least one activity detail 234 for a given communication session. Data collection can be defined as a process of gathering and measuring information on targeted variables in an established systematic fashion, which can optionally be used to evaluate outcomes. Data collection can be a component of research in many industries, however, is particularly relevant in communications systems and network usage, as a number of collectible data types are available for any initiated or ended communication sessions.

A data collection application and computing device, for example, activity detail collector 230, as illustrated herein, can be any combination of computing hardware or software that facilitates the process of data collecting, allowing for the collection of specific, structured information to be gathered in a systematic fashion for subsequent data analysis.

An activity detail, which, for purposes of this exemplary embodiment, is illustrated as at least one activity detail 234, can generally be defined as a “record of data.” One non-limiting example of activity detail 234, specifically if a communication session is a “voice” session, can include what is commonly known in the industry as a call detail record (CDR), which can be defined as a data record produced by a telephone or other telecommunications equipment exchange that documents the details of the telecommunications transaction that passes from one device to another device. Commonly, CDRs may contain various attributes of a call, for example, time, duration, completion status, source number, destination number, and the like.

Activity detail 234 may also, by way of another non-limiting example, be metadata, otherwise known as “data about data,” or data that describes a specific instance of a communication session or communication transaction (even though it does not include the actual content of the communication session or communication transaction). Additional examples of the types of data that may be captured as part of activity detail may optionally include, the start time of a transaction, a duration, phone number or IP addresses associated with initiating and destination devices, billing address associated with the initiating and destination devices, identification of the type of device engaged in the transaction, a unique sequence of numbers, letters, and symbols identifying the record or the transaction, routing information, the disposition of the transaction, i.e., whether or not the call or transaction was connected, the route which the communication session entered an exchange, the route which the communication session exited an exchange, session type, any encountered fault conditions, and the like. One knowledgeable in the art should recognize the difference in activity detail (i.e., activity detail 234) as communication data, traffic data, and metadata as compared to the content of the communication session.

A database, such as, for example, database 232, can be defined as any directory comprising information, and for purposes of the exemplary embodiment illustrated in FIG. 2, identifying characteristics of communication sessions within an entity, specifically between employees and the like, associated with an entity. Database 232 can be relational, in one exemplary embodiment (i.e., tabular with data defined so that it may be reorganized and accessed in a number of ways), in another exemplary embodiment, distributed (i.e., dispersed or replicated among different points in the network), or have any other configuration which is operably functional.

As illustrated in FIG. 2, activity detail 234 can comprise any number, combination, or type of communication session details, also known in the industry as “metrics,” including for purposes of this exemplary embodiment, but in no way limited to an IP address of an initiating device 235, an IP address of a destination device 236, at least one session type 237, a session duration 238, and a time stamp 239. An IP address of an initiating device 235, IP address of a destination device 236, and session type 237 may have the same or substantially the same meanings as how those terms are defined above.

A session duration, such, as for example, session duration 238 can generally be defined as the length of time the communication session continues or exists. In additional embodiments, session duration 238 may further include a start time and a stop time for a communication session, and the like. Yet still further embodiments are contemplated where a communication session contains one or more session time, that session duration 238 may include start and stop times, and separate duration calculations for the various different session types.

Timestamp 239, as illustrated in FIG. 2, may be defined as a sequence of characters or encoded information identifying when a certain event occurred, usually providing date and time of day information for a particular communication session. Additional embodiments are contemplated where time stamp 239, especially for certain session types which may include the digital date and time information, for example, a time associated with the last modification of digital data or a document, a digital time stamp added to a visual file (via, for example, a digital camera or video recording device), and the like. Additional embodiments are contemplated where time stamp 239 may be a “real-time” recordation of an event, as compared to the time in which the event or communication session is recorded by a computing element or device (such as, for example, network monitor 220 or activity detail collector 230). Timestamp 238 may have any format as required by a particular entity, for example, a time code, a “Unix time” (i.e., the number of seconds since 00:00:00 UTC on Jan. 1, 1970), an Internet control message protocol (ICMP) timestamp, a digitally signed timestamp whose signer vouches for the existence of the signed document or content (i.e., at the time given as part of the digital signature), a modification or access time of file or directory in a computing system or database, a proof of the authenticity of an image (i.e., if an image is time-stamped it asserts the image is an original), and the like.

Additional embodiments of activity detail 234 are further contemplated, wherein additional items of data are collected, for example, but no way in limitation, a frequency of at least one term 291 used within a communication session, a record of at least one document exchanged 292, a purpose of the communication session 293, and the like. Information such as these items is often captured via a methodology known as data mining. Data mining is commonly defined as a computing process of discovering patterns in large data sets involving methodologies associated with machine learning, statistics, and business intelligence. Data mining usually involves six common classes of tasks, anomaly detection (the detection of unusual data records), association rule learning (dependency modeling), clustering (discovering groups and structures in that data that are similar), classification (generalizing known data structures to apply to new data), regression (modeling the data with the least error based on estimated relationships among data or datasets), and summarization (providing a more compact representation of the dataset). Data mining as a method step, as part of the functionality of activity detail collector 230 will be discussed in more detail with reference to FIGS. 4 and 5, below.

FIG. 2 further illustrates evaluator 240, which is functionally operable to assess any one, all, each, or wholly the collected activity detail 234. Evaluator 240 can be defined as any computing element or device, series or groupings of computing elements or devices, which judge and determine the significance, worth, and quality of collected activity detail 234 collected by activity detail collector 230 and stored in database 232. As used in the claims and this specification, assessing may include, but is not limited to any analysis method, such as, for example, inspecting or carefully reviewing, grouping, or placing in arrangements as part of a static or dynamic organization for classification, and analyzing, which may include separating into constituent parts, determining essential features, critical examination to identify possible results, or other mathematical or grammatical analysis.

Evaluator 240 employs a set of weighted values 242 to assess the activity detail 234 collected. A weight function is a mathematical device used when performing, for example, a sum, integral, or average of a data set to give certain elements of the data set more “weight” or influence on the result than other elements in the same data set. Generally, a result of this application of a weighted function is a weighted sum or weighted average. Additional embodiments are contemplated where various weight function models are employed, by way of example but no way in limitation, in a discrete mathematics setting, positive functions may be applied to a typically finite or countable dataset, where only relative weights are relevant. In a continuous mathematical setting, where a quantity is measured or recorded multiple, independent times, the best estimate can be obtained by averaging all of the measurements with weight, and the resulting variance may be smaller than each of the independent measurements.

Alternatively, the expected value of a random variable can be the weighted values of the possible values it may take on, i.e., with the weights being the respective probabilities. Generally, the expected value of a function of a random variable is the probability-weighted average of the values the function takes on for each possible value of the random variable. In a regression model, as another alternative model, in which the dependent variable is assumed to be affected by both current and lagged (i.e., past) values of the independent variable, a distributed lag function can be optionally estimated, this function generally being a weighted average of the current and various lagged independent variable values. Another exemplary model may include a moving average model, which can optionally specify an evolving variable as a weighted average of current and various lagged values of a random variable.

Additional embodiments are contemplated where the set of weighted values 242 can optionally comprise weights for a connection type 294, a strength of a connection 295, a secondary connection 296, and a predetermined organization chart for the entity 297. Additional embodiments are further contemplated where the set of weighted values 242 is dynamic based on a network criteria 298, or optionally static.

A connection type, such as connection type 294 may be defined as at least one of the various ways in which communication devices, such as, for example, communication connection representor 210, computing devices, communication nodes, and the like, connect to the Internet. Embodiments are contemplated where connection type 294 is any Internet connection methodology, including but not limited to hardwired broadband access, such as, for example, dial-up access, multilink dial-up, integrated services digital networks, leased lines, cable line access, digital subscriber lines (e.g., DSL, ADSL, SDSL, and VDSL), DSL rings, fiber, frame relay, power-line Internet, wireless broadband access, such as, for example, WiMAX, satellite broadband, mobile broadband, wireless ISP, local multipoint distribution services, and the like. Connection type 294 oftentimes would be included in an activity detail, such as activity detail 234, for algorithmic trending of network factors, such as, for example, availability, speed (i.e., data rates, bit rates, bandwidth, device data rates, and the like), network congestion, outages, and the like.

A strength of a connection, representative of the strength of a connection 295, may be defined as analogous to the upload and download speeds of an Internet connection. A strength of a connection is also commonly known in the industry as “signal strength” which can fluctuate based on a number of factors, such as, for example, background “noise” in an Internet environment, the quantity of users on a network, desired data rates, application use, and the like. Signal strength is often expressed in milliwatts (mW) and decibels relative to a milliwatt (dBm). Generally, minimum required signal strengths for a functionally operable communication session to be routed through various communication nodes would be within the range of −67 dBm to −70 dBm.

Any connected network may have both a primary and a secondary Internet connection, comparable to secondary connection 296, which can generally act as a backup so that if the primary connection fails, a communication node remains connected to the Internet.

An organization chart, such as, for example, predetermined organization chart for the entity 297 generally comprises a diagram graphically depicting the relation of one official to another, or others, of an entity. Predetermined organization chart for the entity 297 may also, for example, be used to show the relation of one department to another, or others, or of one function of an organization to another, or others. Chart 297 may be valuable in that it enables one to visualize a complete organization, by means of the picture it presents. An entity's organizational chart typically illustrates relations between people within the organization. Such relations might include managers to sub-workers, directors to managing directors, chief executive officer to various departments, and so forth.

Network criteria, homologous to network criteria 298 may be defined generally as conditions and characteristics of a network that are used as factors or benchmarks to optimize individual communication sessions or classes of communication sessions via a network. Examples of network criteria include, but are not limited to, bandwidth requirements, a maximum tolerable packet loss rate, one or more allowable applications, number of active on-premises devices simultaneously engaged in communication sessions, a maximum tolerable delay in voice, a maximum tolerable jitter, a minimum video frame rate, allowable geographical locations of intermediate nodes, etc. Generally, the network criteria may impact business rules and vice versa.

Additional embodiments are contemplated where the set weighted values 242 for evaluator 240 can be set by an entity network administrator based on an entity profile. For purposes of this specification and the claims, an entity network administration can be a person who maintains the computing infrastructures within the entity with emphasis on networking. Tasks associated with network administration can include but are not limited to, network monitoring, testing a network for weakness, keeping an eye out for needed updates, installing and implementing security programs, filtering, and evaluating and implementing new network elements. Generally, a network administrator uses a series of computing applications to perform these functions, and as part of the inventive concept as embodied in communication connection representor 210, a network administrator may rely on testing and monitoring functions completed by, for example, network monitor 220, activity detail collector 230, evaluator 240, controller 260, and the like.

As discussed in reference to FIG. 2, an entity profile can generally be defined as a profiling method which results in an in-depth blueprint of an organization's structure, technology, people, processes, upstream and downstream customers, and their relationships. Generally using an entity profile structure, an entity may be able to identify where interlinked relationships occur, however, this methodology alone may prove problematic in determining patterns, for example, patterns of communications, types of documents frequently exchanged, or subject matter often discussed as part of communication sessions and the like.

Profiling can also be used to identify employee perspective and how employees view the entity. Organizational structure often times affects organization-level action, for example, but in no way in limitation, by providing a foundation on which standard operating procedures and routines may rest and determining which individuals get to participate in which decision-making processes (i.e., to what extent their views shape the entity's actions). As such, determining patterns of how these individuals use communication within the entity, in one example, seeing a correlation between a loss in sales due to lack of information given to sales staff (as determined by the types of communications transmitted to and from said sales staff), can provide both information on a system or process inefficiency as well as visually displaying how inaction by a sales staff can substantially affect an entity's actions.

FIG. 2 further illustrates constructor 250 for aggregating the assessed activity detail 234 into a representation of a communication flow, and as illustrated in FIG. 2, connection graph 252. Constructor 250 can optionally serve to express, designate, stand for, denote, or symbolize the analyzed, examined, and grouped data in such a way that the data is depicted as a display of patterns which a user may readily ascertain information from. For purposes of this specification and the claims, aggregating the assessed activity detail 234 may be defined as forming, by the conjunction or collection of particular activity detail 234 data elements into a whole mass, sum, combined assemblage, or body.

As used in reference to FIG. 2, throughout this specification, and the claims, connection graph 252 can be defined as a graphing methodology relating to connectivity. Graph theory, in general, is the study of mathematical structures used to model pairwise relations between objects. In this context, a graph, such as, for example, connection graph 252, may be made up of vertices, nodes, or points, which may be connected by edges, arcs, or lines. In this way, connection graph 252 can be used to model many types of relations and processes in both social and information systems (i.e., to create “metrics,” as discussed above). In certain environments, the term “network” can be synonymous with “graph.” In one example, in mathematics and computer science, “connectivity” can be one of the basic concepts of graph theory: it asks for the minimum number of elements (i.e., nodes or edges, in this context not to be confused with communication nodes and network edge devices, which are not analogous for purposes of this discussion of graph theory) that need to be removed to disconnect the remaining nodes from each other. This can be closely related to the theory of communication network flow problems. The connectivity of a graph, in this environment, can be an important measure of a network's resilience.

A graph, generally, can be “connected” when there is a path between every pair of vertices. In a connected graph, such as that is contemplated for connection graph 252, there are no unreachable or hanging vertices. Conversely, a graph that is not connected is “disconnected” if there exist two nodes such that no path within the graph has those nodes as endpoints. For purposes of the claims and this specification, a graph with one or more, but at least one vertex is considered connected and in the alternative, an edgeless graph with two or more vertices is considered disconnected.

Connection graph types, elements, and requirements are discussed below in more detail, with reference to FIGS. 4 and 5, in which the methodology of graph creation and functionality as part of communication connection representor 210 data representation via a display device will be further defined.

FIG. 2 also illustrates controller 260, which can be a central processing unit for communication connection representor 210, i.e., its electronic circuitry which carries out any computer-executable instructions, by performing, for example, the basic arithmetic, logical, control, and input/output operations, which may be necessary for the operable functionality of communication connection representor 210 or, optionally, specified by the computer-executable instructions to effectively operate, direct, or control any, all, or a combination of network monitor 220, activity detail collector 230, evaluator 240, constructor 250, and control 260 elements receiver 262 and transmitter 264. Additionally, computer executable instructions of this nature are, by way of non-limiting example, often stored in some form of memory, which for ease of illustration in FIG. 2 is not depicted as an element of communication connection representor 210, nonetheless, connection or coupling to some form of memory is intended.

Controller 260 may further comprise a receiver 262 for receiving a notification of a communication session initiated within a network. Receiver 262 can be defined as any combination of computing hardware and software which can receive a communication session, a notice of a communication session, and the like. Controller 260 may additionally comprise transmitter 264, which can be any combination of computing hardware and software for sending, dispatching, passing, or transmitting connection graph 252 via a network to a display device.

FIG. 3 illustrates one exemplary embodiment of a system 300 for determining and displaying communication flow within an entity 360. As contemplated, system 300 may comprise any number of elements, such as, by way of non-limiting example, computing hardware and software, telecommunications hardware and software, network elements such as routers and switches, and the like. FIG. 3, however, illustrates only a subset of elements for simplicity of illustration and is not intended to be limiting on the inventive concept. As illustrated, system 300 comprises communication connection representor 310, entity network 350, a first asset 381, a second asset 382, and a display device 383.

As represented in FIG. 3, system 300 is illustrated as communication connection representor 310 operably connected to entity network 350. Entity network 350, in turn, is operably connected to entity 360, which further comprises (i.e., houses) first asset 381, second asset 382, and display device 383. For purposes of this illustrative exemplary embodiment, first asset 381, second asset 382, and display device 383 are depicted as operably connected to one another and directly to entity network 350. Additional embodiments are further contemplated where the connection configuration between the elements 381, 382, and 383 can be any connection method, by way of example and no way in limitation, hardwired, via fiber, via cable, wirelessly, via another connecting device or the like. Additional embodiments are contemplated where routing devices and other communications shaping or routing devices sit between elements 381, 382, or 383 and entity network 350. Yet still additional embodiments are contemplated where communication connection representor 310 is not located remotely or separately from entity 360 and the respective elements housed there, instead located within entity 360, or, in yet still additional embodiments, operably connected directly to elements 381, 382, 383 (i.e., as a separate computing device, contained within the same computing device as a virtual element, or the like).

FIG. 3 delineates how, via a connection by, to, or through network 350, communication connection representor 310 monitors network 350 and its connection by, to, or within entity 360, and the collection, evaluation, and aggregation of activity details relating specifically to communication sessions initiated and concluded as between first asset 381 and second asset 382 by connection representor 310. In simple operation, a user of first asset 381 initiates a communication session to a user of second asset 382. The user of second asset 382, upon notification of the communication session, responds as applicable, based on the session type of the communication session (i.e., answering a handset phone call, typing and sending a response to a chat message or email, and the like). The details of this communication session are concurrently or simultaneously captured by communication connection representor 310 as an activity detail (including information such as, for example, the IP address of first asset 381, the IP address of second asset 382, a session type, a duration of the communication, a time stamp, and the like). This captured activity detail is thereafter stored and cataloged in a database accessible to or contained within communication connection representor 310.

Communication connection representor 310, can, for example, as is contemplated by exemplary embodiments of the present system, continuously, simultaneously, or periodically apply a set of weighted values relating to calculations which determine representational factors, such as, for example connection type, connection strength, network criteria, relation to an entity profile or organizational chart, secondary connection, or the like. Once communication connection representor 310 has evaluated and assessed any combination, volume, or other quantity of activity details that have been collected, the results of such weighted calculations may be aggregated and thereafter displayed within a connection graph to a user of display device 383.

Entity network 350, in general, can be defined as a system of interconnected computing devices, nodes, and/or assets. In one example, a network includes the Internet that is a global system of interconnected computers that use the standard Internet protocol suite to serve users worldwide with an extensive range of information resources and services. It will be understood that the term Internet, in reality, is actually a network of networks consisting of millions of private, public, academic, business, and government networks, of local to global scope, that are linked by a broad array of technologies. As referred to herein, nodes generally connect to networks, and networks may comprise one or more nodes.

First asset 381 and second asset 382 can generally be defined as communication endpoints, which are a type of communication network node. Communication endpoints or assets can be an interface exposed by a communicating party or by a communication channel, such as, for example, a “publish-subscribe” topic or a “group-in-group” communication system. Customarily, an asset is a discoverable communication node whose scope may be varied to narrow or broaden the discovery zone, i.e., an asset can facilitate a standard programmable layer of abstraction whereby heterogeneous software systems or subsystems may communicate with each other and that the means of communication are decoupled from the communicating subsystems. Examples of assets include, but are not limited to, communication terminals, handset devices, wireless phones, desktop computers, laptop computing devices, tablets, other handheld computing devices, and the like.

Additional embodiments of first asset 381 and second asset 382 further contemplate other electrical or electronic equipment that is connected to an information technology (IT) infrastructure for an entity or grouping of entities that enables or is related to electronic communications (e.g., communication sessions) between users within the entity or grouping of entities. Traditionally, assets of this nature are business-communications oriented, with examples including but not limited to, VoIP phones, mobile phones, fax machines, conventional Plain Old Telephony System (POTS) phones, smartphones, cordless phones, conference room speakerphones, computers, Bluetooth-enabled phones, laptops, audio/video conferencing equipment, electronic gaming equipment, printers, copiers, tablet computers, or more generally, any kind of network communication device.

Display device 383 can be any output device for presentation of information in a visual or tactile form (e.g., the latter used in tactile electronic displays for blind people). When, in one exemplary embodiment, input information is supplied via an electrical signal, the display can be called an “electronic display.” Examples of a display device can include but are not limited to, televisions, computer monitors, and the like. Additional embodiments of display device 383 contemplate computing devices which can operate a graphical user interface (GUI), which can generally be defined a type of user interface that allows users to interact with the information or data displayed through graphical icons and visual indicators, such as, for example, secondary notation, instead of, in another non-limiting example, text-based user interfaces such as typed command labels or text navigation.

Examples of display devices upon which GUIs may operate include but are not limited to, handheld mobile devices such as MP3 players, portable media players, gaming devices, smartphones, and smaller office and industrial controls. Designing the visual composition and temporal behavior of a GUI is an important part of software application programming in the area of human-computer interaction. Its goal is to enhance the efficiency and ease of use for the underlying logical design of a stored program and increase usability. Methods of user-centered design are used to ensure that the visual language introduced in the design is well-tailored to the tasks.

As illustrated in FIG. 3, communication connection representor 310, which is functionally operable for constructing a representation of a communication flow between first asset 381 and second 382 asset via the entity network 350 can comprise the same or substantially similar elements and components as described with reference to communication connection representor 210 previously illustrated and described in reference to FIG. 2. Communication connection representor 310 is illustrated here, in FIG. 3, as a separate and distinct communication element or communication node, for the sake of simplicity of description and illustration only.

FIG. 4 illustrates one exemplary embodiment of the functional operation of the inventive concept as embodied in communication connection representor 210, as depicted in FIG. 2. FIG. 4 illustrates a logical flow diagram generally showing one embodiment of a process or method for determining and displaying communication flow within an entity via a communication connection representor, such as, for example, communication connection representor 210. Method 400 can be implemented in part, or whole, within connection representor 210 of FIG. 2, or in additional embodiments, such as communication connection representor 310 illustrated in FIG. 3, which is characterized as one component of system 300. Furthermore, it is contemplated that steps can be either or both added or removed from method 400. Additionally, it is contemplated that steps can occur concurrently, simultaneously, or periodically, in addition to the exemplary sequential manner in which the steps are ordered, numbered, and described below. The following detailed description, therefore, is not to be taken in a limiting sense, and various embodiments envisioned by either or both adding and removing steps in the process and step completion order may be readily combined, without departing from the scope or spirit of the invention.

Method 400 starts at 402, and thereafter at 410 a network monitor element of a communication connection representor monitors a network to which a communication connection representor and a network monitor are operably connected. At 420, a network monitor receives a notification of a communication session initiated within a network associated with an entity. In the context of this methodology, a communication session generally comprises a series of data packets plus a series of informational packets, which may optionally include information about a communication session, such as, including but not limited to, an Internet protocol (IP) address of a device from which a communication initiated, routing information to route a communication session through a network to a destination device, a communication session type, and the like.

Additional embodiments are contemplated where a network monitor observes a limited network for interpreting the notification of a communication session. In these exemplary embodiments, a limited network can generally be defined as a network accessible only by one entity or a finite grouping of entities. Yet still additional embodiments are contemplated where a network monitor observes all available networks for interpreting a notification of a communication session. In these additional exemplary embodiments, all available networks can generally be defined as one or more or a plurality of networks accessible by an entity and at least one external party.

An activity detail collector element of a communication connection representor collects at 430 and thereafter stores at 440 one or more, but at least one activity detail for a communication session. Data collection at 430 can generally be defined as the process of gathering and measuring communication activity details based on targeted variables in an established, systematic fashion. Commonly, a data collection system comprises a computing application, such as, for example, activity detail collector 230 as illustrated in FIG. 2, that facilitates the process of data collection, allowing specific, structured information to be systematically gathered, to allow for data analysis to be performed, i.e., to enable a computing element, in one example evaluator 240 as depicted in FIG. 2, to apply algorithms, business rules, in one exemplary embodiment, a set of weighted values, and the like.

Storing at 440 occurs by an activity detail collector element of a communication connection representor allocating the collected activity detail to a database. A database, for purposes of the claims and this specification, can generally be defined as a directory comprising information identifying characteristics of activity details. A database can be, in one exemplary embodiment, relational (i.e., tabular with data defined so that it may be reorganized and accessed in a variety of ways by a user, such as a network administrator), distributed (i.e., dispersed or replicated among different points in a network), or have any other configuration that is operably functional for an entity or as defined by a network administrator.

An activity detail can generally be defined as metadata, or data about data, containing data fields that describe a specific instance of a communication transaction, but itself does not include the content of the transaction. As used herein, an activity detail comprises at least one of an IP address of a device from which a communication session initiates, an IP address of a destination device at which a communication session concludes, a communication session type, a communication session duration, a time stamp, and the like. Additional embodiments contemplate, by way of example and no way in limitation, an activity detail that further comprises a frequency of at least one term used within a communication session, a record of at least one document exchanged, or a purpose of a communication session.

Additional embodiments of an activity detail further comprise the phone number of a “calling party” or a “called party,” the starting time of a communication, an initiating phone number, an identification of the telephone exchange or equipment writing the record, a unique sequence number identifying the detail, additional digits on a called number to route or change the call disposition or the results of the call, whether a communication was connected or not, the route by which the communication entered or left an exchange, any fault condition encountered, and the like.

Yet still additional embodiments of an activity detail can comprise Internet protocol (IP)-based service usage and other activities that can be used by business or operation support systems, such as, for example, encoding and transport protocols to exchange records, service specifications, origin, destination, route, time, date, size, duration, type of underlying service, and the like.

At 450, an evaluator element of a communication connection representor assesses a collected activity detail. Assessing can generally be defined as inspecting, grouping, and analyzing. Inspecting generally means to examine, scrutinize, investigate, or study. Grouping can be defined as an act or process of placing in groups, arranging, ordering, organizing, classifying, and combining. Analyzing, for purposes of the claims and this specification can generally be defined as separating data into its constituent parts and determining the elements or essential features, to examine critically to identify key factors, causes, or possible results. When assessing the collected activity detail, an evaluator element of a communication connection representor uses a set of weighted values. These weighted values can include but are not limited to weights for at least one connection type, at least one strength of a connection, at least one secondary connection, and a predetermined organization chart for the entity. In additional exemplary embodiments of the present method, weighted values can be created by an entity network administrator based on an entity profile to inspect, group and analyze the collected activity detail. Additional embodiments are further contemplated where a set of weighted values can be dynamic based on network criteria or static, based on the needs of the entity.

At 460, a constructor element of a communication connection representor aggregates a set of assessed activity details into a representation of a communication flow, which can visually be displayed, for example, as a connection graph. Aggregation occurs at the constructor element of a communication connection representor via any functional aggregation method that includes the collection of a set of particular data points into a mass or total. Additional embodiments are contemplated where a constructor element of a communication connection representor uses an another or a second set of weighted values to aggregate one or more, but at least one, activity detail into a representation of a communication flow. A connection graph, as used herein, can generally be defined in the same or similar manner as above, in reference to FIG. 2.

At 470, a controller element of a communication connection representor transmits a connection graph over a network to a display device. At 480, a display device element of a communication connection representor displays a connection graph. The method thereafter ends at 404. Additional embodiments are further contemplated where this method 400 is sequentially continuous and instead of ending at 404 restarts at 402.

FIG. 5 illustrates one exemplary embodiment of the functional operation of the inventive concept as embodied in system 300, as depicted in FIG. 3. FIG. 5 illustrates a logical flow diagram generally showing one embodiment of a process or method for a determining and displaying communication flow within an entity via a system of interconnected computing elements, such as, for example, system 300. Method 500 can be implemented in part, or whole, within the various computing elements as shown in FIG. 3, or in additional embodiments, such as communication connection representor 210 illustrated in FIG. 2. Furthermore, it is contemplated that steps can be either or both added or removed from method 500. Additionally, it is contemplated that steps can occur concurrently, simultaneously, or periodically, in addition to the exemplary sequential manner in which the steps are ordered, numbered, and described below. The following detailed description, therefore, is not to be taken in a limiting sense, and various embodiments envisioned by either or both adding and removing steps in the process and step completion order may be readily combined, without departing from the scope or spirit of the invention.

Method 500 starts at 502, and thereafter at 510 a network monitor element of a communication connection representor monitors a network to which a communication connection representor and a network monitor are operably connected. At a concurrent step 512, a first asset operably connected to a network initiates a communication session, and for sake of illustration only, to a second asset. At 514, a second asset, which is also operably connected to the network receives a communication session from a first asset. The network monitor, as a portion of a transmission between a first asset and a second asset, at 520, receives a notification of a communication session initiated within a network associated with an entity.

Additional embodiments are contemplated where a network monitor observes a limited network at 510 for interpreting a notification of a communication session at 520. In these exemplary embodiments of a limited network, the same or substantially similar that limited network defined in reference to FIG. 4, can be accessible only by one entity or a finite grouping of entities. Yet still additional embodiments contemplated where a network monitor observes all available networks at 510 for interpreting a notification of a communication session 520. In these additional exemplary embodiments, all available networks can be one or more or a plurality of networks accessible by an entity and at least one external party.

If at 516, the network monitor determines that a communication session has successfully connected, occurred, or is occurring (depending on the embodiment), an activity detail collector element collects at 530 and thereafter stores at 540 one or more, but at least one activity detail for a communication session. Data collection at 530 can generally be defined as the process of gathering and measuring communication activity details based on targeted variables in an established, systematic fashion. Commonly, a data collection system comprises a computing application, such as, for example, activity detail collector 230 as illustrated in FIG. 2, that facilitates the process of data collection, allowing specific, structured information to be systematically gathered, to allow for data analysis to be performed, i.e., to enable a computing element, in one example evaluator 240 as depicted in FIG. 2, to apply algorithms, business rules, in one exemplary embodiment, a set of weighted values, and the like.

Storing at 540 occurs by an activity detail collector element of a communication connection representor allocating the collected activity detail to a database. A database, for purposes of the claims and this specification, can generally be defined as a directory comprising information identifying characteristics of activity details.

An activity detail can generally be defined as metadata, or data about data, containing data fields that describe a specific instance of a communication transaction, but itself does not include the content of the transaction. As used herein, an activity detail comprises at least one of an IP address of a device from which a communication session initiates, an IP address of a destination device at which a communication session concludes, a communication session type, a communication session duration, a time stamp, and the like. Additional embodiments contemplate, by way of example and no way in limitation, an activity detail which may further comprise a frequency of at least one term used within a communication session, a record of at least one document exchanged, or a purpose of a communication session.

Additional embodiments of an activity detail further comprise the phone number of a “calling party” or a “called party,” the starting time of a communication, a billing phone number, an identification of the telephone exchange or equipment writing the record, a unique sequence number identifying the detail, additional digits on a called number to route or change the call disposition or the results of the call, whether a communication was connected or not, the route by which the communication entered or left an exchange, any fault condition encountered, and the like.

Yet still additional embodiments of an activity detail can comprise Internet protocol (IP)-based service usage and other activities that can be used by business or operation support systems, such as, for example, encoding and transport protocols to exchange records, service specifications, origin, destination, route, time, date, size, duration, type of underlying service, and the like.

At 550, an evaluator element of a communication connection representor assesses a collected activity detail. Assessing can generally be defined as inspecting, grouping, and analyzing. Inspecting generally means to examine, scrutinize, investigate, or study. Grouping can be defined as an act or process of placing in groups, arranging, ordering, organizing, classifying, and combining. Analyzing, for purposes of the claims and this specification can generally be defined as separating data into its constituent parts and determining the elements or essential features, to examine critically to identify key factors, causes, or possible results. When assessing the collected activity detail, an evaluator element of a communication connection representor uses a set of weighted values. These weighted values can include but are not limited to weights for at least one connection type, at least one strength of a connection, at least one secondary connection, and a predetermined organization chart for the entity. In additional exemplary embodiments of the present method, weighted values can be created by an entity network administrator based on an entity profile to inspect, group and analyze the collected activity detail. Additional embodiments are further contemplated where a set of weighted values can be dynamic based on network criteria or static, based on the needs of the entity.

At 560, a constructor element of a communication connection representor aggregates an assessed activity detail, an at least one assessed activity detail, one or more assessed activity details, or a series of assessed activity details into a representation of a communication flow, and for the sake of simplicity of illustration herein, in one example, a connection graph. Aggregation occurs at the constructor element of a communication connection representor via any functional aggregation method that includes the collection of a set of particular data points into a mass or total. Additional embodiments are contemplated where a constructor uses an another or a second set of weighted values to aggregate one or more, but at least one, activity detail into a connection graph. A connection graph, as used herein, can generally be defined in the same or similar manner as above, in reference to FIG. 2.

At 570, a controller element of a communication connection representor transmits a connection graph over a network to a display device. At 580, a display device element of a communication connection representor displays a connection graph. The method thereafter ends at 504. Additional embodiments are further contemplated where this method 500 is sequentially continuous and instead of ending at 504 restarts at 502.

Additional methods, aspects, and elements of the present inventive concept are contemplated to be used in conjunction with, individually or in any combination thereof which will create a reasonably functional communication representor, systems, and methods. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention.

Moreover, particular exemplary features described herein in conjunction with specific embodiments or aspects of the present invention are to be construed as applicable to any embodiment described within, enabled through this written specification and claims, or apparent based on this written specification and claims. Thus, the specification and drawings are to be regarded in a broad, illustrative, and enabling sense, rather than a restrictive one. It should be understood that the above description of the embodiments of the present invention is susceptible to various modifications, changes, and adaptations, and the same are intended to be comprehended within the meaning and range of equivalents of the appended claims.

We claim:

1. A communication connection representor for constructing a representation of a communication flow within an entity, the communication connection representor comprising:
a network monitor for interpreting a network notification of an initiated communication session associated with the entity, the communication session comprising an Internet protocol (IP) address of an initiating device, routing information, and an at least one session type;
an activity detail collector for collecting and storing in a database an at least one activity detail for the communication session, the at least one activity detail comprising the IP address of the initiating device, the at least one session type, an IP address of a destination device, a session duration, and a time stamp;
an evaluator for assessing the at least one activity detail, wherein the evaluator applies a set of weighted values stored at the evaluator to the activity detail;
a constructor for aggregating the assessed at least one activity detail into a representation comprising a connection graph; and
a controller capable of:
receiving the notification of the communication session; and
transmitting the constructed connection graph via the network to a display device.

2. The communication connection representor of claim 1, wherein the set of weighted values is set by an entity network administrator based on an entity profile.

3. The communication connection representor of claim 1, wherein the set of weighted values comprises weights for at least one of: an at least one connection type, an at least one strength of a connection, an at least one secondary connection, or a predetermined organization chart for the entity.

4. The communication connection representor of claim 1, wherein the set of weighted values comprises weights for an at least one connection type, an at least one strength of a connection, an at least one secondary connection, and a predetermined organization chart for the entity.

5. The communication connection representor of claim 1, wherein the set of weighted values is dynamic based on a network criteria.

6. The communication connection representor of claim 1, wherein the set of weighted values is static.

7. The communication connection representor of claim 1, wherein the network monitor observes a limited network for interpreting the notification of the communication session, wherein the limited network comprises a network accessible only by the entity.

8. The communication connection representor of claim 1, wherein the network monitor observes all available networks for interpreting the notification of the communication session, wherein all available networks comprise a plurality of networks accessible by the entity and at least one external party.

9. The communication connection representor of claim 1, wherein the at least one activity detail further comprises a frequency of at least one term used within the communication session.

10. The communication connection representor of claim 1, wherein the at least one activity detail further comprises a record of at least one document exchanged.

11. The communication connection representor of claim 1, wherein the at least one activity detail further comprises a purpose of the communication session.

12. A system for constructing a representation of a communication flow within an entity, the system comprising:
an entity network;
at least one first asset operably connected to the entity network;
at least one second asset operably connected to the entity network
a display device; and
at least one communication connection representor for constructing the communication flow between the at least one first asset and the at least one second asset via the entity network, the communication connection representor comprising:
a network monitor for interpreting a network notification of an initiated communication session associated with the entity, the communication session comprising an Internet protocol (IP) address of an initiating device, routing information, and an at least one session type;
an activity detail collector for collecting and storing in a database an at least one activity detail for the communication session, the at least one activity detail comprising the IP address of the initiating device, the at least one session type, an IP address of a destination device, a session duration, and a time stamp;
an evaluator for assessing the at least one activity detail, wherein the evaluator applies a set of weighted values stored at the evaluator to the activity detail;
a constructor for aggregating the assessed at least one activity detail into a representation comprising a connection graph; and
a controller capable of:
receiving the notification of the communication session; and
transmitting the connection graph via the network to the display device.

13. The system of claim 12, wherein the set of weighted values is set by an entity network administrator based on an entity profile.

14. The system of claim 12, wherein the set of weighted values comprises weights for at least one of an at least one connection type, an at least one strength of a connection, an at least one secondary connection, or a predetermined organization chart for the entity.

15. The system of claim 12, wherein the set of weighted values comprises weights for an at least one connection type, an at least one strength of a connection, an at least one secondary connection, and a predetermined organization chart for the entity.

16. The system of claim 12, wherein the set of weighted values is dynamic based on a network criteria.

17. The system of claim 12, wherein the set of weighted values is static.

18. The system of claim 12, wherein the network monitor observes the entity network and an at least one other available network for interpreting the notification of the communication session, wherein the at least one other available network comprises a plurality of networks accessible by the at least one first asset, the at least one second asset, and at least one third asset which has access to the entity network.

19. The system of claim 12, wherein the at least one activity detail further comprises a frequency of at least one term used within the communication session.

20. The system of claim 12, wherein the at least one activity detail further comprises a record of at least one document exchanged.

21. The system of claim 12, wherein the at least one activity detail further comprises a purpose of the communication session.

22. A method for constructing a representation of a communication flow within an entity, comprising:
monitoring a network via a network monitor, wherein monitoring comprises the network monitor receiving a network notification of an initiated communication session associated with the entity, the communication session comprising an Internet protocol (IP) address of an initiating device, routing information, and an at least one session type;
collecting and storing an at least one activity detail for the communication in a database via an activity detail collector, wherein collecting and storing comprises the activity detail collector storing at least one of the IP address of the initiating device, an IP address of a destination device, the at least one session type, a session duration, and a time stamp;
assessing the collected at least one activity detail via an evaluator, assessing comprises the evaluator applying a set of weighted values stored at the evaluator to inspect, group and analyze the collected at least one activity detail;
aggregating the assessed at least one activity detail into a connection graph via a representor, wherein aggregating comprises the representor using a second set of weighted values to aggregate the at least one activity detail into the connection graph;
transmitting the connection graph via a controller over the network to a display device; and
displaying the connection graph via the display device.

23. The method of claim 22, wherein the set of weighted values is set by an entity network administrator based on an entity profile.

24. The method of claim 22, wherein the set of weighted values further comprises weights for at least one of an at least one connection type, an at least one strength of a connection, an at least one secondary connection, or a predetermined organization chart for the entity.

25. The method of claim 22, wherein the first set of weighted values further comprises weights for at least one connection type, at least one strength of a connection, at least one secondary connection, and a predetermined organization chart for the entity.

26. The method of claim 22, wherein the first set of weighted values and the second set of weighted values are dynamic based on a network criteria.

27. The method of claim 22, wherein first set of weighted values and the second set of weighted values are static.

28. The method of claim 22, wherein the network monitor observes a limited network for interpreting the notification of the communication session, wherein the limited network comprises a network accessible only by the entity.

29. The method of claim 22, wherein the network monitor observes all available networks for interpreting the notification of the communication session, wherein all available networks comprise a plurality of networks accessible by the entity and at least one external party.

30. The method of claim 22, wherein the at least one activity detail further comprises a frequency of at least one term used within the communication session.

31. The method of claim 22, wherein the at least one activity detail further comprises a record of at least one document exchanged.

32. The method of claim 22, wherein the at least one activity detail further comprises a purpose of the communication session.
